(19) United States
(12) Patent Application Publication
(10) Pub. No.: US 2024/0291087 A1
(43) Pub. Date: Aug. 29, 2024

(54) Battery Module Housing for a Battery Module, Battery Module, and Electrical Energy Store

(71) Applicant: Mercedes-Benz Group AG, Stuttgart (DE)

(72) Inventor: Anselm MUELBERGER, Wernau (Neckar) (DE)

(21) Appl. No.: 18/559,998

(22) PCT Filed: Sep. 22, 2022
(86) PCT No.: PCT/EP2022/076409

§ 371 Date: Nov. 9, 2023

(30) Foreign Application Priority Data
Oct. 1, 2021 (DE) 10 2021 004 937.3

(51) Int. Cl. H01M 50/242; H01M 50/211

(52) U.S. Cl. CPC H01M 50/242; H01M 50/211; H01M 2220/20

(57) ABSTRACT

A battery module housing for a battery module, where a battery cell undergoes a change in volume in accordance with a cell state, includes a module frame which forms at least one first receiving region for the battery cell and a second receiving region for a pressure-regulating device. The pressure-regulating device is in contact with the battery cell and is formed for adjusting a predetermined pressure value on the battery cell in accordance with the change in volume. The pressure-regulating device has at least one first tube-like and flexible pressure body and a separate second tube-like and flexible pressure body. A movable intermediate pressure plate which is at least partially in contact with the first pressure body and the second pressure body is formed between the first pressure body and the second pressure body.

### BACKGROUND AND SUMMARY OF THE INVENTION

The invention relates to a battery module housing for a battery module of an electrical energy store having at least one battery cell. Further, the invention relates to a battery module as well as to an electrical energy store.

Battery module housings are already known from the prior art, which are formed for an electrical energy store, for example in motor vehicle construction. At least one battery cell, in particular a plurality of battery cells, can then be installed inside the battery module housing, wherein the battery module housing therefore forms a frame for the battery cells. The battery cells can, for example, be pouch cells, which carry out a change in volume in accordance with a cell state, in particular in accordance with a current state of charge and in accordance with an age of the battery cell. This change in volume is also referred to as cell respiration. Here, it is important that the change in volume of the battery cell can be compensated for inside the battery module housing. Further, it is necessary in, for example, prismatic cells that a predetermined pressure value is exerted on the battery cells, so that an improved performance of the battery cells can be obtained.

According to DE 10 2018 204 220 A1, a battery is disclosed comprising at least one battery cell, wherein every battery cell has a plurality of parallel-stacked electrodes and a pressure device by means of which a pressure can be applied to the electrodes. A frame is closed on all sides. The pressure device and the at least one battery cell are arranged inside the frame in a longitudinal direction of the frame such that if the pressure device exerts pressure, a pressure region of the pressure device presses against the electrodes in the longitudinal direction and a support region of the pressure device that is opposite the pressure region is supported by a first frame wall of the frame in a longitudinal direction opposite to the longitudinal direction.

EP 3 189 552 A2 relates to a clamping device for battery cells, wherein a reservoir that comprises a chamber with a variable volume is formed for receiving fluids and wherein the reservoir is formed such that a battery cell or a plurality of battery cells can be clamped.

DE 10 2019 007 748 A1 relates to an electrical energy store having at least one electrode stack, which comprises a plurality of layers of electrodes arranged above each other in a stacking direction and separators arranged between the electrodes. At least one pressure plate is provided to exert a pressure on the electrode stack that acts against the stacking direction. At least one actuator is provided for applying a force to the pressure plate. The electrode stack and the pressure plate are arranged in a housing of the electrical energy store. The electrical energy store has a control unit for controlling the at least one actuator. The control unit is configured to cause a substantially constant force to be applied to the pressure plate by means of the actuator depending on the respective thickness of the at least one electrode stack.

It is the object of the present invention to provide a battery module housing, a battery module as well as an electrical energy store by means of which an improved operation of a battery cell can be realized.

A first independent aspect of the invention relates to a battery module housing for a battery module of an electrical energy store having at least one battery cell, wherein the at least one battery cell undergoes a change in volume in accordance with a cell state, having at least one module frame which forms at least one first receiving region for the at least one battery cell and a second receiving region for a pressure-regulating device of the battery module housing, wherein the pressure-regulating device is at least partially in contact with the at least one battery cell in the assembled state of the battery module and is formed for adjusting a predetermined pressure value on the battery cell in accordance with the change in volume.

It is thereby provided that the pressure-regulating device has at least one first tube-like and flexible pressure body and a separate second tube-like and flexible pressure body, wherein a movable intermediate pressure plate which is at least partially in contact with the first pressure body and the second pressure body is formed between the first pressure body and the second pressure body.

In particular, an improved operation of the at least one battery cell can thus be realized, since in particular a continuous and simpler construction of the pressure-regulating device can be provided. In particular, reliably and constantly distributed pressure can be exerted on the at least one battery cell on the basis of the tube-like and flexible pressure body. By means of the first pressure body and the second pressure body, small changes in volume can therefore be realized inside the pressure bodies, whereby, on the basis of the at least two pressure bodies, a corresponding pressure value can then nevertheless be reliably exerted. The intermediate pressure plate is in particular formed, for example, to exert the pressure of the first pressure body constantly and evenly distributed onto the second pressure body, wherein the second pressure body is in contact with the at least one battery cell, for example via a pressure plate. It can then in particular be provided that, in the exemplary embodiment presented, the first pressure body is, for example, supported on the module frame, whereby the corresponding pressure value can then be exerted on the at least one battery cell, which supports itself on an opposite side of the module frame.

By means of using several pressure bodies or a plurality of pressure bodies, a large volume compensation of the volume-variable cells can occur in an additionally space-saving manner.

By the movable intermediate pressure plate is here in particular to be understood that this can change position, in particular move, inside the module frame, according to change in volume or pressure regulation.

In particular, applying the pressure body to the full surface of the intermediate pressure plate and of the pressure plate and therefore accurately determining the force on the respective plates can therefore be realized via the tube pressure. To this end, in particular no sensor is needed, which saves costs. Further, there is no sagging of the pressure plate. Furthermore, a low pressure level in the tube in comparison to, for example, air bellows, can be realized at the same cell pressure. Further, the block length is very small in comparison to an air bellows solution, so that installation space can be saved. Furthermore, there is high installation space flexibility, since the tube-like pressure bodies in particular can be better integrated in the rectangular and mostly flat installation space of the battery module housing or of the battery module than corresponding air bellows or cylinders. Further, it should also be noted that weight is saved, since the corresponding tube-like pressure bodies are very thin and light. The pressure plate or the intermediate pressure plate can also be very slim and made of materials with a low thickness. A very uniform pressure distribution can thereby in particular be realized on the battery cell surface.

The invention therefore in particular solves the object that the at least one battery cell, in particular a plurality of battery cells, must be clamped inside the battery module, here inside the battery module housing. The battery cells are in particular so-called pouch cells or prismatic cells, which, for example, have a reinforced cell respiration, wherein the cell respiration describes a change in volume or the so-called state of charge. A system that compensates for the change in volume is therefore necessary. It can additionally be provided that some battery cells necessitate a so-called clamping force, i.e., a pressure orthogonal to the battery cell surface in order to correspondingly be able to function. For example with solid state cells, the layers of which are pressed together using pressure, such a clamping force is necessary in order to optimize the surface contact and to reduce the cell resistance. Further, a corresponding clamping force can, for example, be necessary in so-called lithium metal anodes, which build up as a layer during the charging process and break down during the discharging process. In particular, the so-called cell respiration therefore arises. Moreover, it is necessary to compress such battery cells in order to thus enable the precipitation processes or depositing processes so that flat layers can build up and break down. To this end, it is in particular necessary that the pressure on the battery cells must be provided at all times, whereby the pressure-regulating element, which can in particular also be referred to as the pressure-applying element, must be in contact with the cell at all times despite a change in volume of the battery cell, and apply a force.

It is further provided that the first pressure body and/or the second pressure body has a reinforcement on respective edge regions and/or corner regions. For example, should the battery module housing be provided as substantially cuboid-shaped, a reinforcement can be provided in corresponding corners so that a high lifespan of the first pressure body and of the second pressure body can be recorded.

According to an advantageous embodiment, the first pressure body and/or the second pressure body are formed from a rubber-like material. In particular, the first pressure body and the second pressure body can therefore be provided in a type of bicycle tube. It is thereby made possible, in a simple manner, that the pressure regulation can be carried out inside the battery module housing. These are in particular very lightweight and affordable materials, so that the first pressure body and the second pressure body can be provided inside the battery module housing in a highly flexible manner.

It is also advantageous if at least the first pressure body and the second pressure body are fluidically connected with each other. A pressure-regulating device is therefore only necessary in order to adjust the pressure in both the first pressure body and also in the second pressure body. Installation space as well as components can therefore be saved.

In a further advantageous embodiment, at least the first pressure body and the second pressure body are fluidically connected with each other via a fluidic connection that is guided through a recess inside the intermediate pressure plate. It is thereby enabled that a fluidic connection can be realized between the first pressure body and the second pressure body in a space-saving manner. The recess can, for example, be provided in the form of a hole or of a cylinder, wherein the first pressure body can then, in turn, be connected or welded with the second pressure body via a connection that is also rubber-like or tube-like. A simple and nevertheless reliable pressure regulation can therefore be provided inside the pressure-regulating device.

It has furthermore been shown to be advantageous if a filling valve for fluidically filling the first pressure body and/or the second pressure body is formed on a module frame. In particular, the module frame only has a single filling valve, wherein the first pressure body and the second pressure body are then also respectively fluidically connected with each other. The first pressure body and/or the second pressure body can therefore be fluidically filled outside the module frame.

It has furthermore been shown to be advantageous if a shape of the first pressure body and/or of the second pressure body at least partially substantially corresponds to the shape of the second receiving region. By means of the flexible, in particular by means of the tube-like and rubber-like first pressure body and/or second pressure body, this can in particular adapt to the shape of the receiving region. Further, the first pressure body and the second pressure body can already have a substantially pre-made shape, for example a substantially rectangular shape, so that an improved pressure distribution can be realized by the first pressure body and/or the second pressure body.

It has furthermore been shown to be advantageous if a cross-section of the first pressure body and/or of the second pressure body is substantially oval or substantially round. In particular, a simple production method of the first pressure body and of the second pressure body is thereby realized. In particular, the first pressure body and/or the second pressure body are flexible such that, after a pressure input, the oval or round shape can adapt to the corresponding shape of the at least second receiving region. A pressure regulation inside the battery module housing can therefore be realized reliably and in a simple manner.

A further aspect of the invention relates to a battery module for an electrical energy store having at least one battery module housing according to the preceding aspect and having at least one battery cell, wherein the at least one battery cell undergoes a change in volume in accordance with a cell state.

Yet another further aspect of the invention relates to an electrical energy store, in particular for an at least partially electrically operated motor vehicle, having at least one battery module according to the preceding aspect. In particular, the electrical energy store can, for example, also have a second battery module according to the preceding aspect. Further, the electrical energy store can also have further battery modules. Furthermore, the electrical energy store can, for example, have a corresponding management system in order to monitor a pressure regulation as well as corresponding states of charge of the battery module. The electrical energy store can, for example, be formed as a traction battery of an at least partially electrically operated motor vehicle.

Furthermore, yet a further aspect of the invention relates to a motor vehicle having at least one electrical energy store according to the preceding aspect. The motor vehicle is in particular formed as an at least partially electrically operated motor vehicle, in particular as a completely electrically operated motor vehicle.

An independent second aspect of the invention relates to a battery module housing for a battery module of an electrical energy store having at least one battery cell, wherein the at least one battery cell undergoes a change in volume in accordance with a cell state, having at least one module frame which forms at least one first receiving region for the at least one battery cell and a second receiving region for a pressure-regulating device of the battery module housing, wherein the pressure-regulating device is at least partially in contact with the at least one battery cell in the assembled state of the battery module and is formed for adjusting a predetermined pressure value on the battery cell in accordance with the change in volume. Here, it is provided that the pressure-regulating device has at least one first tube-like and flexible pressure body, wherein at least the one pressure body is formed from a rubber-like material.

Furthermore, a further independent third aspect of the invention relates to a battery module housing for a battery module of an electrical energy store having at least one battery cell, wherein the at least one battery cell undergoes a change in volume in accordance with a cell state, having at least one module frame which forms at least one first receiving region for the at least one battery cell and a second receiving region for a pressure-regulating device of the battery module housing, wherein the pressure-regulating device is at least partially in contact with the at least one battery cell in the assembled state of the battery module and is formed for adjusting a predetermined pressure value on the battery cell in accordance with the change in volume. It is hereby provided that the pressure-regulating device has at least one tube-like, flexible pressure body, wherein at least the one pressure body has a reinforcement on respective edge regions and/or corner regions.

Advantageous embodiments of the first aspect of the invention are to be seen as advantageous embodiments of the battery module as well as of the electrical energy store and of the motor vehicle. Furthermore, the advantageous embodiments of the first aspect of the invention are also to be seen as advantageous embodiments of both the independent second and third aspects, i.e., the pressure-regulating device having the tube-like, flexible pressure body, wherein the pressure body consists of a rubber-like material and/or wherein the pressure body has a reinforcement on respective edge regions and/or corner regions. The features of the first independent aspect can thereby be freely combined with the features of the second independent aspect as well as of the third independent aspect.

Further advantages, features and details of the invention can be seen in the following description of preferred exemplary embodiments and by reference to the drawings. The features and feature combinations referred to in the description, as well as the features and feature combinations referred to below in the description of the figures and/or shown solely in the figures can be used not only in each specified combination but also in other combinations or alone without leaving the scope of the invention.

### BRIEF DESCRIPTION OF THE DRAWINGS

FIG. 1 is a schematic side view of an embodiment of a motor vehicle with an embodiment of an electrical energy store;

FIG. 2 is a schematic view of an embodiment of a battery module;

FIG. 3 is a further schematic plan view of the battery module according to FIG. 2;

FIG. 4 is a schematic perspective view according to an embodiment of a pressure body of an embodiment of a battery module housing; and

FIG. 5 is a schematic perspective view of an embodiment of a battery module.

### DETAILED DESCRIPTION OF THE DRAWINGS

In the figures, the same or functionally identical elements are provided with the same reference numerals.

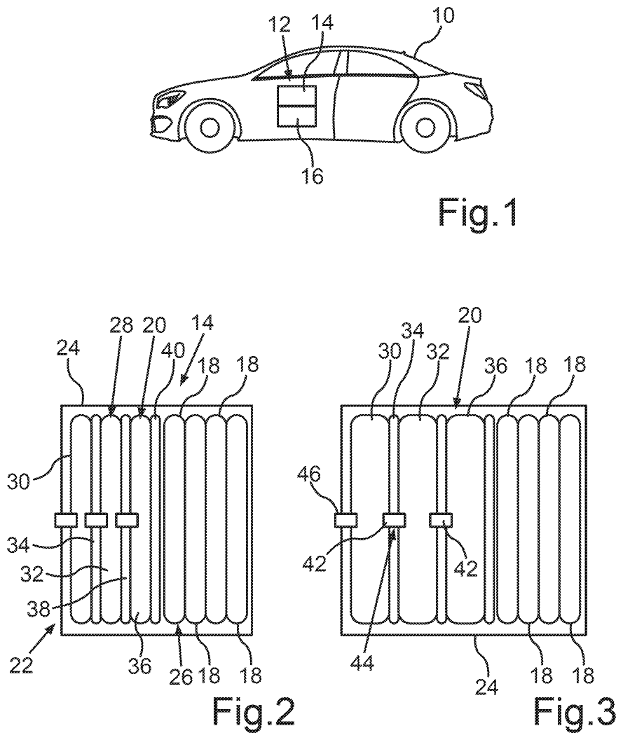

FIG. 1 shows a schematic side view of an embodiment of a motor vehicle 10 with an embodiment of an electrical energy store 12. The motor vehicle 10 can in particular be formed as an at least partially electrically operated motor vehicle, in particular as a completely electrically operated motor vehicle. The electrical energy store 12 can then, for example, be formed as a traction battery for powering an electrical drive device of the at least partially electrically operated motor vehicle 10. Further, the electrical energy store 12 can be formed for operating a wiring system of the motor vehicle 10. Here, the electrical energy store 12 in particular has a first battery module 14 as well as a second battery module 16.

FIG. 2 shows a schematic plan view according to one embodiment of the battery modules 14, 16, wherein the corresponding features are only described for the first battery module 14 below. However, the features can also be applied to the second battery module 16. FIG. 2 therefore in particular shows the first battery module 14. The battery module 14 has at least one battery cell 18, here in particular four battery cells 18. Battery cells 18 are in particular so-called solid-state cells, which operate a cell respiration, and thereby carry out a change in volume in accordance with an ageing state as well as a state of charge of the battery cells 18. To this end, in order to be able to carry out cell respiration, a pressure-regulating device 20 is provided according to the invention. The pressure-regulating device 20 is, in turn, part of a battery module housing 22.

The battery module housing 22 is in particular formed for the electrical energy store 12, wherein at least the one battery cell 18 undergoes a change in volume in accordance with a respective cell state. The battery module housing 22 has, to this end, in particular a module frame 24 which forms at least one first receiving region 26 for the at least one battery cell 18 and a second receiving region 28 for the pressure-regulating device 20, wherein the pressure-regulating device 20 is at least partially in contact with the at least one battery cell 18 in the assembled state of the battery module 14 and is formed for adjusting a predetermined pressure value on the battery cell 18 in accordance with the change in volume.

Here, it is provided that the pressure-regulating device 20 has at least one first tube-like and flexible pressure body 30 and a separate second tube-like and flexible pressure body 32, wherein a movable intermediate pressure plate 34 which is at least partially in contact with the first pressure body and the second pressure body 32 is formed between the first pressure body 30 and the second pressure body 32. It is presently in particular shown that the pressure-regulating device 20 can also have a third pressure body 36, wherein a further intermediate plate 38 is formed between the second pressure body 32 and the third pressure body 36. Furthermore, it can be seen that, in the present exemplary embodiment, a pressure plate 40 is formed between the third pressure body 36 and one of the battery cells 18. Should, for example, the battery module housing 22 only have two pressure bodies 30, 32, then the pressure plate 40 can be formed between the second pressure body 32 and the battery cell 18. The pressure-regulating device 20 can also have more than three pressure bodies 30, 32, 36.

FIG. 3 shows a further schematic plan view according to the exemplary embodiment of FIG. 2. In FIG. 3 it can be seen that the pressure-regulating device 20 has correspondingly “blown up” the pressure bodies 30, 32 and 36 and therefore has adjusted the pressure value, since, for example, a cell respiration of the battery cells 18 is carried out. It can in particular be seen that here, the pressure bodies 30, 32, 36 are supported on the module frame 24. Further, the battery cells 18 are also supported on the module frame 24.

It can in particular be provided that the first pressure body 30 and/or the second pressure body 32 as well as the third pressure body 36 are formed from a rubber-like material. This aspect should also be considered an independent aspect of the invention.

FIG. 3 further shows that at least the first pressure body 30 and the second pressure body 32 are connected with each other via a fluidic connection 42. Furthermore, in the present exemplary embodiment, the second pressure body 32 is also fluidically connected with the third pressure body 36 via the fluidic connection 42. It can hereby in particular be provided that the fluidic connection 44 is guided inside the intermediate pressure plate 34 through a recess 44.

Furthermore, FIG. 3 shows that a filling valve 46 for fluidically filling the first pressure body 30 and/or the second pressure body 32 is formed on the module frame 24.

It can further be provided that a shape of the first pressure body 30 and/or of the second pressure body 32 at least partially substantially corresponds to the shape of the second receiving region 28, wherein it can furthermore be provided that a cross-section of the first pressure body 30 and/or of the second pressure body 32 is substantially oval or substantially round.

FIGS. 2 and 3 therefore in particular show that a fluid can be pumped into the elastic tubes or pressure bodies 30, 32, 36, wherein the fluid can be both compressible, for example air, or also incompressible, for example liquid. The pressure bodies 30, 32, 36 are thereby in particular a tube, wherein other shapes, for example bladders or bellows-shaped elements are also possible. In the case of the tube, the cross-section can, for example, be configured to be round, but also oval. In the case of a tube, the respective open ends can, for example, be welded shut.

The tube itself is not load-bearing and is supported on the module frame 24, whereby it is possible to make the tube very thin and flexible, so that it has a very high deformability. Due to the support, the tube can be blown up to significantly higher pressures than it could, for example, achieve without a casing. Pressure values of greater than 16 bar are hereby attainable, wherein the comparable materials that are in particular used in the bicycle industry can be used. If the thin tube is blown up, then it fills in the cavity of the normally rectangular module shape. The material is flexible such that the tube adjusts to the module geometry. The module cavity is designed such that no sharp edges can damage the tube. Radii are provided such that the tube can fit well. Corresponding gaps are thereby kept to a minimum. A further possibility is that the tube is plastically deformed when it is first blown up and takes on the shape of the module cavity. The tube shapes are thereby, as already mentioned, typically oval, however it is also possible to design a tube shape such that the tube spreads out rather squarely in the cavity. Furthermore, the tube material can be reinforced in certain places, in order to, for example, protect curves/radii.

In order to be able to realize larger strokes, it is possible to insert several tubes in a row and to separate them with thin plates. These plates are in particular referred to as the intermediate pressure plates 34, wherein these do not fulfil a mechanical load-bearing role, rather only serve as a contact surface between the air tubes, so that these do not change shape. If several tubes are placed in a row, then the tubes are in particular connected via corresponding air connections, for example valves or locking devices, that ensure that the fluid pressure is equal between the tubes. One of the tubes, preferably which lies on the module frame, here preferably the first pressure body 30, is supplied with the fluid. This valve is a pressure regulator valve and measures and regulates the pressure in the tubes. The valves and air connections are preferably attached centrally in the intermediate pressure plates 34 and the pressure bodies 30, 32, 36. By means of the pressure valve it is possible to control the pressure in the tubes. Without limiting the invention, other valves and connecting pieces can be inserted, depending on the fluid used.

Since the tubes always make contact with the whole surface of the intermediate pressure plates 34 as well as the pressure plate 40, which represents the transition to the battery cell 18, it is possible to determine the pressure on the battery cells 18 at any time by means of the pressure in the tube. This is only possible since the tube is so thin and flexible that it completely fills up the cavity under the lowest pressure, and takes on its shape. If the material has already plastically deformed after the first inflation and has taken on the geometry of the cavity, the shape also remains, even under very low pressures.

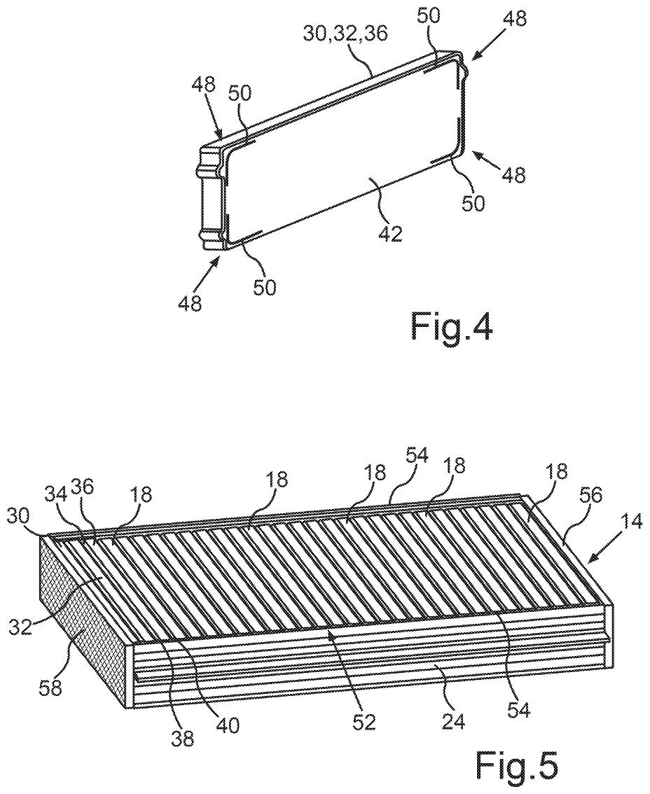

FIG. 4 shows a schematic perspective view according to an embodiment of a pressure body 30, 32, 36. Here, it is in particular shown that the pressure body 30, 32, 36 is substantially rectangular and has adapted to the shape of the battery module housing 22. It is further shown that, in particular in corresponding corner regions 48, reinforcements 50 are formed, so that damage to the pressure bodies 30, 32, 36 is prevented. Here, this is also an independent aspect of the invention, which is therefore to be considered both together with the two pressure bodies 30, 32 and also alone.

FIG. 5 shows a schematic perspective view of an embodiment of a battery module 14. Here, the module frame 24 is in particular shown. Furthermore, the three pressure bodies 30, 32, 36 are shown. The pressure bodies 30, 32, 36 are each separated from each other by the intermediate pressure plates 34, 38. The pressure plate 18 is, in turn, arranged between the third pressure body 36 and the battery cells 18. Here, the battery module 14 has a plurality of battery cells 18. It can hereby in particular be provided that, for example, the battery cells 18 are arranged inside a cartridge guide 52, so that these can move inside the module frame 24 during cell respiration. In other words, the battery cells 18 are suspended moveably in corresponding rails 54 and can correspondingly expand depending on cell respiration and pressure regulation. In particular, FIG. 5 further shows that the battery cells 18 are in particular supported on a first side wall 56 of the module frame 24 and the first pressure body 30 is supported on a second wide wall 58, that is opposite the first side wall 56. By means of this support it is, in turn, made possible that the corresponding pressure value can adjust within the battery cell 14, by means of pressure regulation and the expansion of the battery cells 18.

1.-9. (canceled)

10. A battery module housing (22) for a battery module (14, 16) of an electrical energy store (12) having at least one battery cell (18), wherein the at least one battery cell (18) undergoes a change in volume in accordance with a cell state, comprising:
a module frame (24) which forms at least one first receiving region (26) for the at least one battery cell (18) and a second receiving region (28) for a pressure-regulating device (20) of the battery module housing (22), wherein the pressure-regulating device (20) is at least partially in contact with the at least one battery cell (18) in am assembled state of the battery module (14, 16) and is formed for adjusting a predetermined pressure value on the at least one battery cell (18) in accordance with the change in volume;
wherein the pressure-regulating device (20) has at least one first tube-like and flexible pressure body (30) and a separate second tube-like and flexible pressure body (32);
wherein a movable intermediate pressure plate (34) which is at least partially in contact with the at least one first tube-like and flexible pressure body (30) and the second tube-like and flexible pressure body (32) is formed between the first tube-like and flexible pressure body (30) and the second tube-like and flexible pressure body (32);
wherein the first tube-like and flexible pressure body (30) and/or the second tube-like and flexible pressure body (32) has a respective reinforcement (50) on a respective edge region and/or on a respective corner region (48).

11. The battery module housing (22) according to claim 10, wherein the first tube-like and flexible pressure body (30) and/or the second tube-like and flexible pressure body (32) are formed from a rubber-like material.

12. The battery module housing (22) according to claim 10, wherein the first tube-like and flexible pressure body (30) and the second tube-like and flexible pressure body (32) are fluidically connected with each other.

13. The battery module housing (22) according to claim 12, wherein the first tube-like and flexible pressure body (30) and the second tube-like and flexible pressure body (32) are fluidically connected with each other via a fluidic connection (42) that is guided through a recess (44) inside the intermediate pressure plate (34).

14. The battery module housing (22) according to claim 10, further comprising a filling valve (46) formed on the module frame (24) for fluidically filling the first tube-like and flexible pressure body (30) and/or the second tube-like and flexible pressure body (32).

15. The battery module housing (22) according to claim 10, wherein a shape of the first tube-like and flexible pressure body (30) and/or of the second tube-like and flexible pressure body (32) at least partially corresponds to a shape of the second receiving region (28).

16. The battery module housing (22) according to claim 10, wherein a cross-section of the first tube-like and flexible pressure body (30) and/or of the second tube-like and flexible pressure body (32) is oval or round.

17. A battery module (14, 16) for an electrical energy store (12), comprising:
the battery module housing (22) according to claim 10; and
at least one battery cell (18) disposed in the battery module housing (22), wherein the at least one battery cell (18) undergoes a change in volume in accordance with a cell state.

18. An electrical energy store (12) for an at least partially electrically operated motor vehicle (10), comprising:
a battery module (14,16), wherein the battery module (14, 16) includes:
the battery module housing (22) according to claim 10; and
at least one battery cell (18) disposed in the battery module housing (22), wherein the at least one battery cell (18) undergoes a change in volume in accordance with a cell state
